(19) United States
(12) Patent Application Publication
(10) Pub. No.: US 2005/0181351 A1
(43) Pub. Date: Aug. 18, 2005

(54) Method and apparatus for providing a card with penmanship improving indicia

(76) Inventor: Anthony Balloutine, Totowa, NJ (US)

Correspondence Address: CAHN & SAMUELS LLP, 2000 P STREET NW, SUITE 200, WASHINGTON, DC, 20036, US

(21) Appl. No.: 10/766,196

(22) Filed: Jan. 29, 2004

(51) Int. Cl. B43L 1/00

(52) U.S. Cl. 434/408

(57) ABSTRACT

The present invention contemplates a device and method providing a writing surface such as a face of a greeting card or a sheet of stationary including temporary penmanship improving indicia such as lining or a grid. The invention employs an air-activated, disappearing substance such as ink covered with an overlying ambient environment, sealing barrier sheet preferably removably affixed to the writing surface. To activate the disappearing substance, the user removes the barrier sheet, permitting exposure of the disappearing substance to air, thereby causing a chemical reaction such as oxidation. The user can then utilize the penmanship improving indicia, and his or her writing appears neatly aligned. After a select period of time, e.g., approximately five to ten minutes, the once visible ink disappears, thereby leaving only the user's neatly aligned writing.

### I. FIELD OF THE INVENTION

The present invention relates to greeting cards, and more particularly, to customizable greeting cards.

### II. BACKGROUND OF THE INVENTION

Many people present greeting or gift cards to significant others every year. For example, greeting or gift cards are often mailed to remote loved ones on special occasions such as Christmas, Easter, Thanksgiving, Halloween, St. Valentines Day, anniversaries, baby showers, and the first day of a new year. Although cards marking the foregoing events often exist with standard language or features, they also exist in a format in which a user may add personalize language to achieve a customized effect. For example, a Christmas card may contain a standard drawing of Santa Claus on one side with the opposite side being blank to allow the user to write a personalized note.

In addition to presenting others with greeting or gift cards such as the foregoing types, many individuals use unruled stationary to send letters or notes to other individuals. Regardless of whether a sender uses a greeting card or stationary, however, a sender's writing is often not as clear and legible as it could be. For example, writing on a marking surface which is unruled sometimes results in a note that is illegible, messy, slanted, or jumbled. Although some stationary sheets, for example, provide ruled lines for assisting a writer with writing neatly and legibly, the ruled lines can detract from the stationery's appearance.

In light of the foregoing, what is needed is a greeting or gift card providing penmanship improving indicia such as ruled lines formed of a marking substance (for example, ink) that disappears over a period of time. Such a card should assist a writer in writing neatly and legibly.

### III. SUMMARY OF THE INVENTION

An objective of the present invention is to improve penmanship by minimizing or preventing misalignment of characters.

An advantage of the present invention is that it can be used in conjunction with traditional greeting or gift cards.

Another advantage of the present invention is that it can be used in conjunction with a variety of types of stationary.

Yet another advantage of the present invention is that it is easy to use.

Another advantage of the present invention is that it can be utilized with a variety of types of disappearing ink.

The present invention assists with improving penmanship by providing indicia such as lining or a grid on a writing surface. After the indicia is utilized (for example, after a user writes between the lines), it eventually disappears, providing the user with a more neatly aligned note.

The present invention is a writing surface (for example, the inside face of a greeting or gift card or a sheet of stationary) including penmanship improving indicia such as lining or a grid. The writing surface includes an air-activated, disappearing substance such as ink covered with an overlying, ambient environment, sealing barrier sheet preferably removably affixed to the writing surface. To activate the disappearing substance, the user removes the barrier sheet, permitting exposure of the disappearing substance to air, thereby initiating a chemical reaction such as oxidation. The user can then utilize the penmanship improving indicia, and his or her writing appears neatly aligned. After approximately five to ten minutes, the once visible substance disappears, thereby leaving only the user's neatly aligned writing.

In an alternative embodiment, the invention is preferably a system for providing guidance for writing a note. The system preferably includes a writing surface such as a stationary sheet or greeting or gift card having a guidance means formed of a disappearing substance and an activating cover for initiating a chemical reaction process when placed over the writing surface, thereby causing the once visible substance to disappear.

### V. BRIEF DESCRIPTION OF THE DRAWINGS

Like reference numerals in the figures represent and refer to the same element or function throughout.

FIG. 1 is an example of a greeting or gift card including a removably affixed overlying barrier sheet.

FIG. 2 is an example of a greeting or gift card from which the barrier sheet has been removed to reveal penmanship improving indicia.

FIG. 3 is an example of a stationary sheet including a removably affixed overlying barrier sheet.

FIG. 4 is an example of a stationary sheet from which the barrier sheet has been removed to reveal penmanship improving indicia.

FIG. 5 is an example of an alternative embodiment of the invention including a system for providing guidance for writing a note.

### VI. DETAILED DESCRIPTION OF THE INVENTION

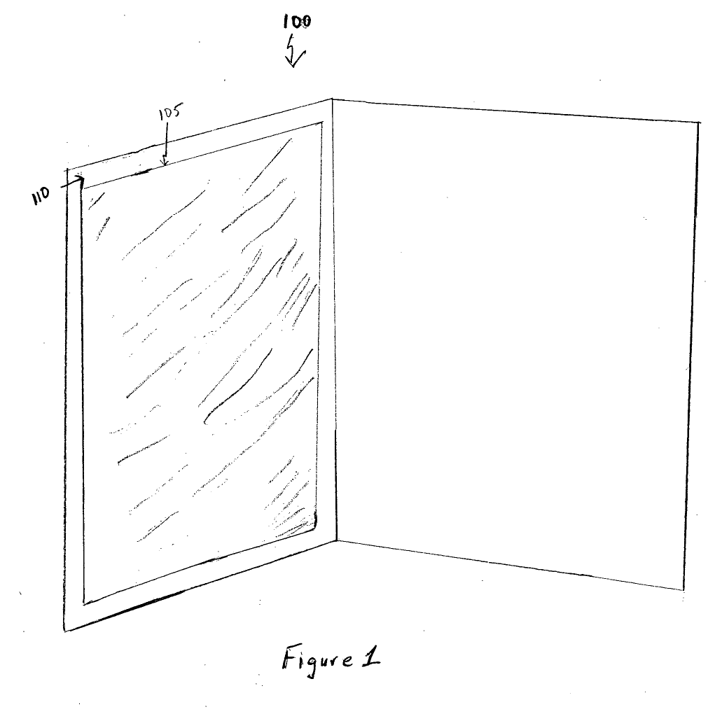

FIG. 1 illustrates greeting or gift card 100. The greeting or gift card 100 is preferably a card that a sender sends to a recipient to mark a special event such as a birthday, an anniversary, Christmas, or the first day of a new year, for example. Alternatively, a sender may also send the greeting or gift card 100 to simply greet a recipient.

After being presented with the disclosure herein, it will be apparent to one skilled in the relevant art that a variety of card types, sizes, and configurations can be utilized in the invention. For example, in at least one embodiment, a card preferably includes a rectangular shape and is manufactured of recycled paper. To enhance warmness and attractiveness, the greeting or gift card may also include an image located on a page of the card.

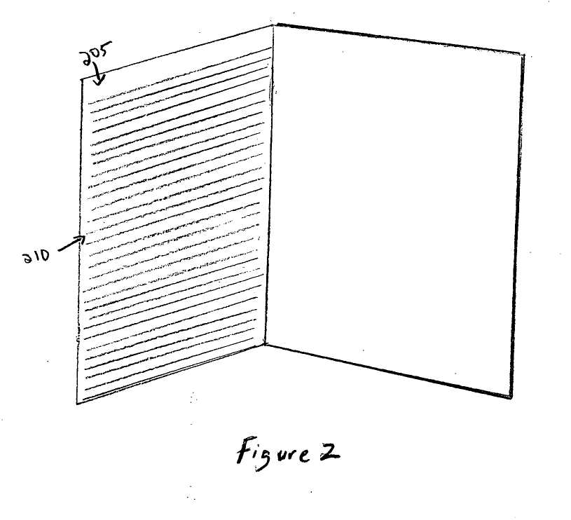

The greeting or gift card 100 provides penmanship improving indicia such as ruled lines that disappear over a period of time. Before the lines disappear, however, the sender is allowed to utilize the penmanship improving indicia to compose a more neatly aligned and legible note. The greeting or gift card 100 preferably includes an overlying ambient environment sealing barrier sheet 105 and a marking area (shown in FIG. 2) located underneath the barrier sheet 105.

The barrier sheet 105 is preferably affixed to a face 110 of the greeting or gift card 100 by any viable means of attaching such a sheet. For example, in at least one embodiment, the barrier sheet 105 is preferably removably affixed to the face 110 by temporary adhesive. After being presented with the disclosure herein, one skilled in the relevant art will realize that a variety of methods may be utilize to attach the barrier sheet 105 to the face 110 of the card 100. The barrier sheet 105 preferably overlies the marking area (shown in FIG. 2) to prevent air from permeating the marking area. The barrier sheet 105 is preferably manufactured of synthetic polymer. The barrier sheet 105 may also be manufactured of any other viable material for preventing the permeation of air to the marking surface. For example, in at least one embodiment of the invention, the barrier sheet 105 is preferably manufactured of light-weight aluminum foil. It should be noted that the extent to which the barrier sheet 105 covers the face 110 may be varied according to embodiments of the invention. For example, the marking area underlying the barrier sheet may encompass only a portion of the face 110 of the card. In such a configuration, the barrier sheet 105 preferably covers the portion encompassing the marking area.

To initiate a chemical reaction process to cause the visible ink to eventually disappear, the sender of the card 100 preferably removes the barrier sheet 105. For example, in at least one embodiment, removal of the barrier sheet 105 causes oxidation to occur.

After the sender removes the barrier sheet 105 to initiate the chemical reaction process, the penmanship improving indicia is preferably revealed. FIG. 2 shows marking area 205. The marking area 205 preferably includes the penmanship improving indicia 210. In at least one embodiment of the present invention, the penmanship improving indicia 210 preferably includes a plurality of ruled lines for assisting the sender with presenting a neatly aligned, legible note. The ruled lines preferably serve as a guide and assist the sender in preventing his or her writing from slanting or “jumbling.” As a result, the sender is presented with a neatly aligned, legible note.

As previously mentioned, penmanship improving indicia such as ruled lines sometimes detracts from the appearance of a written note. Thus, in the present invention, the penmanship improving indicia 210 will preferably eventually disappear, as it is formed of a disappearing substance such as disappearing ink. For example, in the embodiment described above, the ruled lines preferably disappear after approximately ten minutes. It should be noted, however, that the time interval in which it takes the lines to disappear varies according to the particular type of chemical reaction utilized in a particular embodiment of the invention. After being presented with the disclosure herein, it should become apparent to one having ordinary skill in the relevant art that a variety of types of disappearing inks may be utilized in the present invention.

Regardless of the type of chemical reaction or disappearing substance utilized, the recipient preferably receives a card or stationary with a more attractive, neatly aligned, legible note. Slanting or jumbling of the writing comprising the note is preferably minimized or prevented.

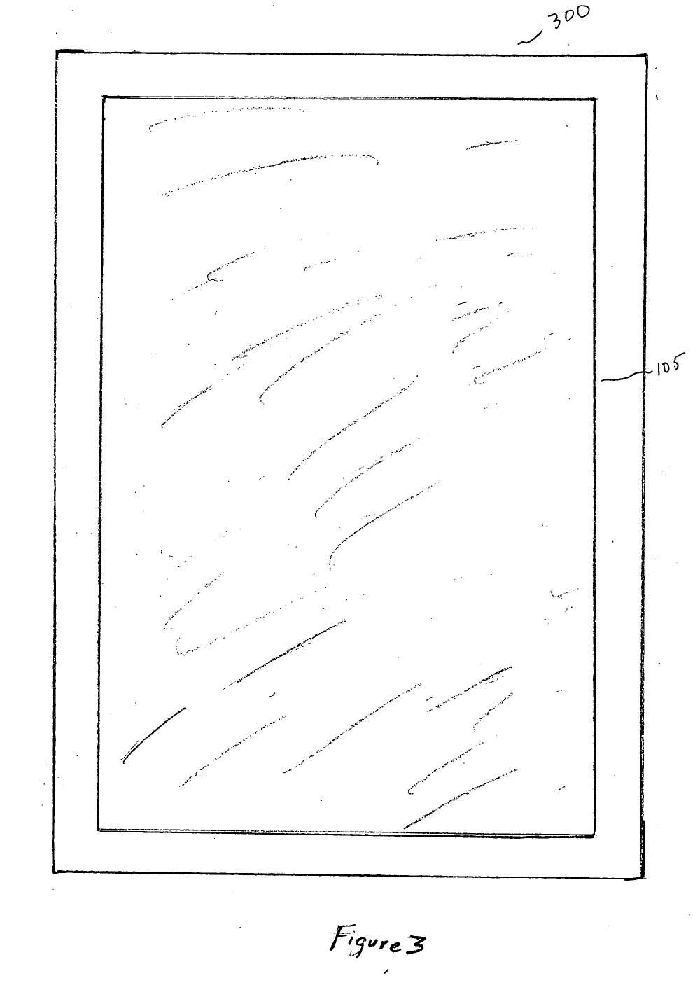

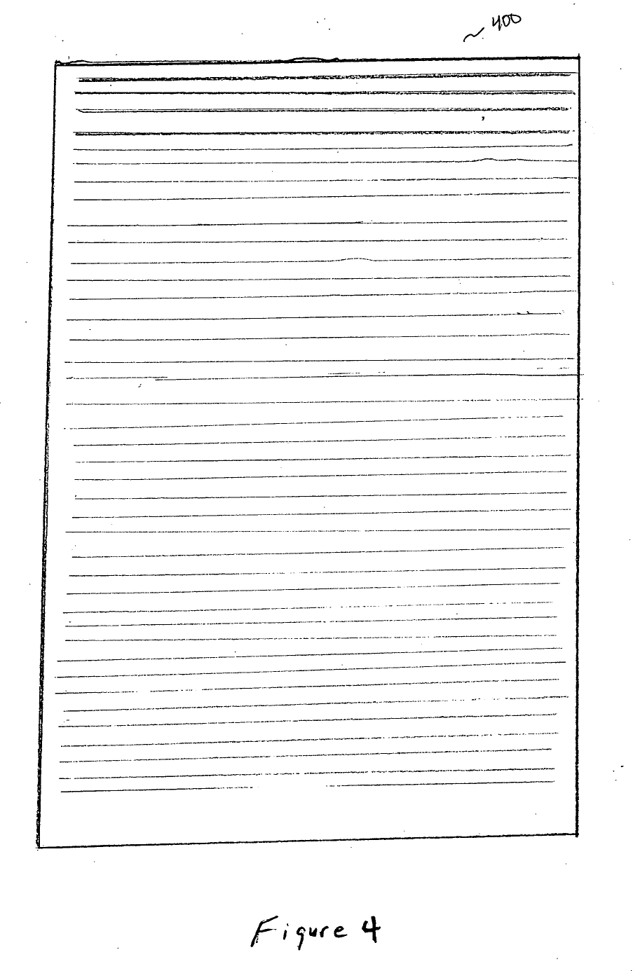

After being presented with the disclosure herein, one skilled in the relevant art will realize that the present invention may be embodied in other configurations without departing from the scope and spirit of the invention. For example, in addition to a greeting or gift card, the present invention may be utilized on a stationary sheet such as that shown in FIGS. 3 and 4.

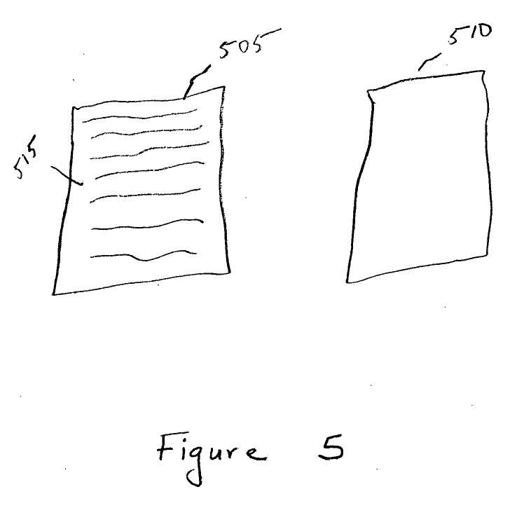

FIG. 5 illustrates system 500 for providing guidance for writing a note. The system 500 includes a writing surface 505 and an activating cover 510.

In at least one embodiment, the writing surface 505 is the face of a card or a sheet of stationary, such as that illustrated in FIGS. 2 and 4, respectively. The writing surface 505 preferably includes a guidance component 515 formed of a substance capable of eventually disappearing such as ink. For example, in at least one embodiment, the guidance component 515 is a plurality of ruled lines, as illustrated in FIG. 5.

In at least one embodiment, the activating cover 510 is preferably manufactured of a synthetic polymer sheet. It should be noted, however, that the activating cover 510 may be manufactured of any other viable material. For example, in at least one embodiment, the activating cover 510 is preferably treated with a chemical for initiating a chemical reaction when placed atop the writing surface. For example, in at least one embodiment of the present invention, the activating cover 510 is treated with a reactionary agent that reacts with the substance on the writing surface to initiate a chemical reaction.

After utilizing the guiding component 515 (for example, after writing a note between the plurality of ruled lines), the writer preferably places the activating cover 510 over the writing surface 505 and gently rubs or presses the cover 510. When the cover 510 is gently rubbed or pressed, the chemical contained thereon reacts with the disappearing substance with which the guidance component 515 is formed, thereby initiating the chemical reaction. The chemical reaction preferably causes the guiding component to disappear from the card. As a result, the sender is preferably provided with a card having a more neatly aligned note without the plurality of rules lines, for example.

Those skilled in the art will appreciate that various adaptations and modifications of the above-described embodiments of the present invention can be configured without departing from the scope and spirit of the present invention. Therefore, it is to be understood that, within the scope of the appended claims, the invention may be practiced and constructed other than as specifically described herein.

1. A marking surface operable to be written on, drawn on or otherwise marked by a user, comprising:
a marking area comprising penmanship improving Indicia comprising ink capable of disappearing; and
an overlying barrier sheet for preventing permeation of air, said overlying barrier sheet being removably affixed to the marking area;
wherein removal of said overlying barrier sheet initiates a chemical reaction process in which said ink disappears after passage of a certain amount of time.

2. The marking surface of claim 1, wherein said barrier sheet is a sheet of synthetic polymer.

3. The marking surface of claim 1, wherein said barrier sheet is a sheet of lightweight aluminum foil.

4. The marking surface of claim 1, wherein said marking area includes an area for writing a note between a plurality of lines formed from said ink.

5. The marking surface of claim 1, further comprising a series of instructions located on said barrier sheet.

6. A system for providing guidance for writing a note, comprising:
a writing surface Including a guidance means formed of a substance capable of disappearing; and
an activating cover for initiating a reaction process when placed over said writing surface, thereby causing said substance to disappear.

7. The system of claim 6, wherein said activating cover is treated with a reactionary agent reacting with said substance on said writing surface to cause said substance to disappear.

8. The system of claim 6, wherein said activating cover is a sheet of synthetic polymer.

9. The system of claim 6, wherein said activating cover is a sheet of light-weight aluminum foil.

10. A method for providing a writing surface with penmanship improving indicia, comprising:
treating the writing surface with a disappearing substance to form the penmanship improving indicia; and
covering the writing surface with an air-impermeable cover to prevent exposure of the writing surface to air.

11. A system as claimed in claim 6, wherein said activating cover comprises a chemical for initiating the reaction process when the activating cover is placed over said writing surface.
